(19) United States
(12) Patent Application Publication
(10) Pub. No.: US 2009/0290023 A1
(43) Pub. Date: Nov. 26, 2009

(54) Self contained wall mountable surveillance and security system

(76) Inventors: JASON GUY LEFORT, MAULDIN, SC (US); LAURA CHRISTINE ROSS, CLAYTON, NY (US)

Correspondence Address: JASON G LEFORT, UNIT B15, 1200 WOODRUFF ROAD, GREENVILLE, SC, 29607, US

(21) Appl. No.: 12/126,099

(22) Filed: May 23, 2008

(51) Int. Cl. H04N 7/18

(52) U.S. Cl. 348/151; 348/E07.085

(57) ABSTRACT

A surveillance system that is comprised of an environmentally sealed metal cabinet enclosure consisting of high impact resistant metal, said enclosure consists of a metal back and having two equal metal sides and an equal top and bottom pieces that are framed and fastened in such a manner as to form a framed rectangular metal box style enclosure. A front mounted metal access door with two recessed metal hinges, a rubberized gasket to form a seal and an attached locking device and handle complete the cabinet enclosure. Side access ports of at least one per side, and generally being round in nature provide a side access point to the interior of the cabinet, said access ports provide a mounting point for the generally hollow camera mounting arm to be attached to each side of said cabinet. The said access ports allow wiring and cables to pass through the connected camera mounting arm to the interior of the cabinet, with said camera mounting arm ends being environmentally sealable, thus rendering the wiring and cable protected from the environment and secure from tampering or accidental damage. The cabinet contains and houses the various subsystem components consisting of, but not limited to, a video encoding device, communication equipment and various control systems for powering and controlling the plurality of pan, tilt and zoom cameras with analytic capabilities, sensor apparatus, various warning devices and having at least one, but not limited to one, power source providing power to the plurality of electronic devices. Secondly, a programmable LED digital message board is positioned and attached at or near the top of the cabinet to provide a highly visible visual warning that the area is under surveillance.

### TECHNICAL FIELD OF THE INVENTION

The present invention relates to the field of video surveillance and security, wherein the surveillance requirements call for the installation of a permanent or long term surveillance presence.

### BACKGROUND

### Description of the Related Art

The use of a variety of surveillance equipment, cameras and other electronic devices are well known in the art as a means of surveillance and monitoring activities at various events and locations.

Often a video surveillance system is comprised of a single camera mounted to a structure and fixed on a single limited area of view, such as a door or entrance gate, and the video is then sent via cable to a single video monitor to observe the area, and may also be connected to some type of recording device to capture and record the video image. As the need for security and monitoring increases additional cameras and equipment may be added, these additions are often comprised of mismatched components requiring additional wiring, complex time consuming installation, troubleshooting and maintenance, often resulting in poor performance and the inability of the security system to perform the desired task. A self-contained surveillance system can address these needs and provide the flexibility and solutions to meet today's security issues.

Security system cameras are generally mounted to the side of a building or wall, or often affixed to a pole or other structure that require extensive wiring and cabling, often resulting in cable runs in excess of hundreds of feet, this type of installation is often difficult, time consuming, inefficient, as well as expensive. This type of surveillance system generally requires that all components be wired and connected back to a central point for monitoring, and additional wiring is needed to provide power to the various surveillance devices. Often in these types of systems signal degradation occurs as a result of the extended length of said cable runs, requiring the addition of signal amplification and other equipment to provide a signal boost back to the video monitors at a central monitoring point. In addition the difficulties of running wires and cable through and around buildings or over and under roadways and high traffic areas cause significant obstacles to this type of installation. Additional upgrades, service, repair and maintenance to these types of surveillance systems are often difficult and inflexible due to the positioning of the required equipment. The self-contained wall mountable surveillance system addresses these areas of need and provides the solution to the deficiencies of current surveillance systems.

### BRIEF SUMMARY OF THE INVENTION

In the embodiment of the claimed invention an environmentally sealed metal cabinet is utilized to house a complete self-contained wall mountable surveillance system (referred to herein as “surveillance system”) with attached closed circuit surveillance pan, tilt and zoom (referred to herein as “PTZ camera”) cameras with analytics capabilities.

The embodiment of the claimed invention contains a complete surveillance system including but not limited to, a central processing unit for controlling and programming the plurality of electronic surveillance devices and other electrical and electronic devices and apparatus contained within said metal cabinet.

In the embodiment of the claimed invention is an analytics object tracking, object recognition central processing unit, to work in conjunction with the PTZ cameras with analytics capabilities and to communicate with the plurality of electronic devices contained within the surveillance system.

In a further embodiment of the claimed invention a video encoder is incorporated into said surveillance system to record and analyze data received from the PTZ cameras and said video recorder works in unison with the analytics object tracking object recognition central processing unit to facilitate the auto-tracking automatic zoom capabilities of the PTZ cameras.

In the embodiment of the claimed invention the self-contained surveillance system utilizes at least one power source or a variety of power sources, including but not limited to, battery or a series of batteries, a power cable connected to a common 120 v AC 60 hz power source, a portable generator, a photovoltaic array, a wind generator, a fuel cell or any other device capable of providing standard power to the surveillance system.

In a further embodiment the security system can include a communication device or series of communications devices contained within the surveillance system, and be in communication with other devices and equipment mounted inside the surveillance system. For example, the communication device can report on activity or events detected by a plurality of surveillance devices located within or attached to the surveillance system and record said information for later analysis or report this information to a central monitoring station as required, either immediately in real time, or at specified pre-programmed timed intervals. Said communication devices then have the ability to receive instructions from said central monitoring station or other authorized users through a plurality of communication devices and communicate said instructions to other surveillance devices located within or attached to said security system.

In a further embodiment, the surveillance system communications can include one or more of the following communications devices, satellite link, Wi-Fi, cellular, ultra long range industrial grade wireless ethernet systems 128 bit hardware encryption keys and wired ethernet systems. Said communication devices can communicate with, but not limited to, a designated central control monitoring station, a computer based communications system and a video decoder with communications ability. Said communication devices can communicate with, or receive communications from a variety of separate and distinct communication devices, including but not limited to, computer systems, cellular telephones, blackberry devices, PDAS, pagers and central monitoring stations. The plurality of said communications devices allow for a two way communications system with the various surveillance components within and attached to the surveillance system and allows authorized users to receive and communicate with, and to send instructions to the surveillance system as required.

In the embodiment of this invention the use of specialized video surveillance pan, tilt and zoom cameras (PTZ cameras) with analytics capabilities and with the ability to, and working in conjunction and harmony with, the video encoder and the plurality of the entire surveillance system to autonomously and without human intervention to select, identify and track a specific intrusion and or target and with the ability to remain locked on said target regardless of movement or direction said target undertakes within the designated security zone to be protected, and to zoom in and capture real time images of said target and store data for later retrieval or to communicate said data in real time to an authorized user, but not limited to continually manned central monitoring stations, make this invention a clear and distinct improvement to the current embodiments of aforementioned surveillance systems. Secondly, the addition of the programmable LED digital message board offers a highly visible warning that the area is under video surveillance.

While it is to be understood that the description of the invention and its' embodiments are hereto explained in detail, it is to be understood that the claimed invention is not limited to the arrangement of details, or to the arrangement and construction presented in the following descriptions. And that the claimed invention has a variety of uses and is not limited to the descriptions depicted in the following paragraphs.

It should be noted that the invention and the embodiments of the invention include hardware, electronic devices and components, software and other manufactured components and devices.

One possessing ordinary skill in the art, should upon reading this description and possessing common knowledge of the art and its' related fields should, in a reasonable timeframe, be able to understand, manufacture and implement said claimed invention.

### BRIEF DESCRIPTION OF THE DRAWINGS

FIG. 1 depicts a front view of a self contained wall-mountable surveillance system as constructed in the current embodiment of the invention.

FIG. 2 depicts a view of the assembly process and various components that comprise the attachment of the PTZ cameras to the surveillance system.

FIG. 3 depicts a block diagram view of the plurality of electronic surveillance equipment and communications apparatus in the current embodiment of the claimed invention.

FIG. 4 depicts a perspective view of the surveillance system as constructed in the current embodiment of the invention.

FIG. 5 depicts the wall mounting bracket assembly attached to the box plate rear panel.

FIG. 6 depicts a view of the surveillance system both as a wall mount and as a ceiling mountable unit.

### DETAILED DESCRIPTIONS OF THE DRAWINGS

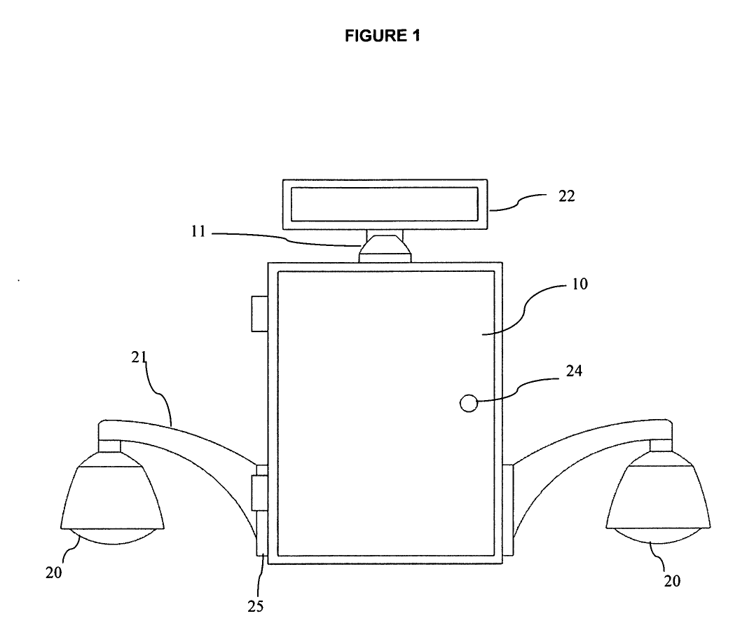

In reference to FIG. 1 the self-contained wall mountable surveillance system is depicted in its completed form. The surveillance system is comprised of an environmentally sealed metal cabinet enclosure 10 consisting of impact resistant metal, said enclosure consists of a metal back and having two equal metal sides and an equal top and bottom pieces that are framed and fastened in such a manner as to form a framed rectangular box style enclosure. A front mounted metal access door 23 with two recessed metal hinges (not shown), with a rubberized gasket (not shown) to form a seal, and an attached locking device and handle 24 complete the cabinet enclosure 10. An electric fan (not shown) or combination of electric fans mounted within the cabinet enclosure serve to provide cooling air to the plurality of electronic apparatus and aids in the evaporation of any moisture or condensation that may enter the cabinet.

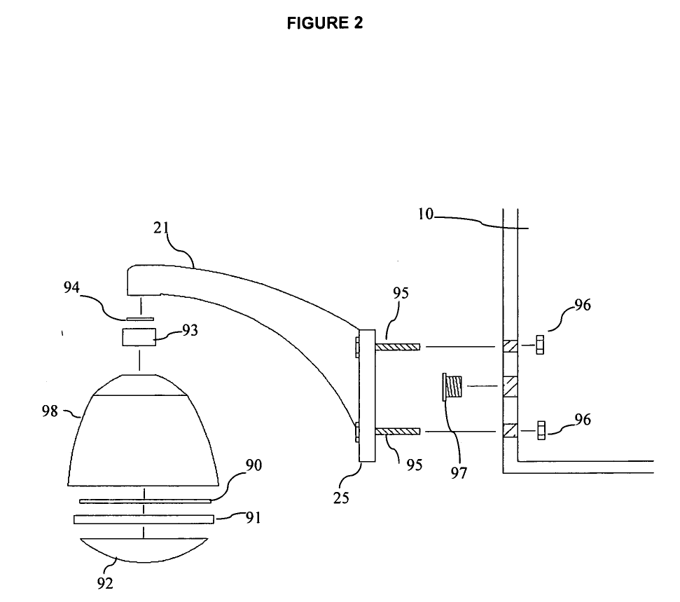

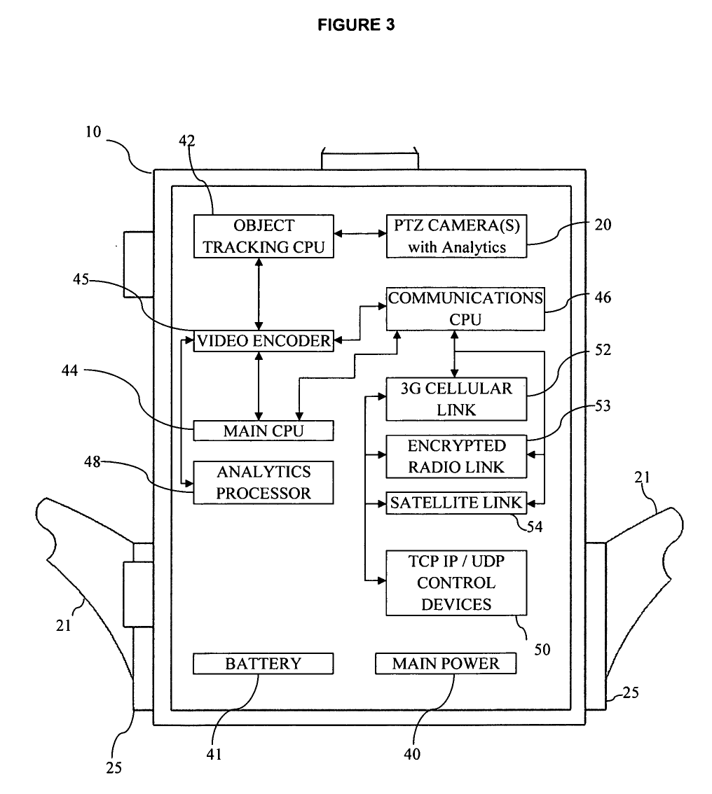

In reference to FIG. 2 side access ports, of at least one per side (not shown), and generally being round in nature, provide a side access point to the interior of the cabinet enclosure 10, said access ports provide a mounting point for the generally hollow camera mounting arm 21 and a camera arm mounting plate 25 to be attached to each side of said cabinet. The said access ports allow wiring and cables to pass through the connected camera mounting arm 21 to the interior of the cabinet 10, with said camera mounting arm 21 end being environmentally sealable by a rubberized gasket contained within a plastic threaded nut, 97 thus rendering the wiring and cable protected from the environment and secure from tampering or accidental damage. The cabinet 10 contains and houses the various subsystem components depicted in FIG. 3. and the security system having at least one power source or a variety of power sources, including but not limited to, battery or a series of batteries 41, a power cable connected to a common 120 v AC 60 hz power source 40, a portable generator, a photovoltaic array, a wind generator, a fuel cell or any other device capable of producing standard type power to the security system.

In further reference to FIG. 2 the process that renders the PTZ cameras environmentally sealed is described, the PTZ camera(s) 20 are housed inside the main housing assembly 98, the Plexiglas dome lens cover 92 is fastened to the PTZ main housing assembly 98 by means of a threaded locking ring 91 and sealed by a rubberized gasket 90. The PTZ camera housing 98 is then attached to the camera mounting arm 21 by a generally locking style threaded plastic nut 93 and sealed with a rubberized gasket 94, the wiring and cable is then passed from the camera mounting arm 21 through a generally hollow plastic locking threaded nut 97 which is fastened to the cabinet enclosure 10. The camera mounting arm 21 is then attached to the cabinet enclosure 10 by means of the mounting plate 25 and rubberized gasket (not shown) which is fastened to the cabinet enclosure 10 by means of four metal bolts 95 and tightened by four threaded nuts 96 on the interior of the enclosed cabinet enclosure 10.

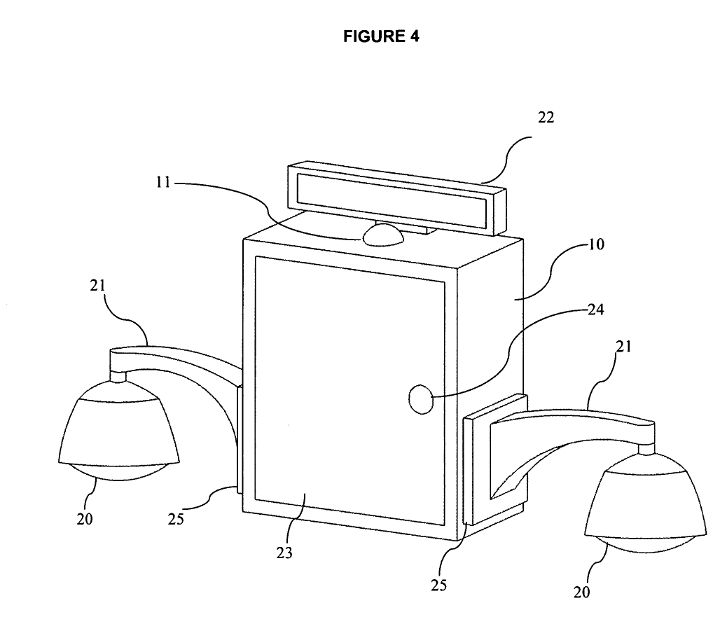

In reference to FIG. 4 a perspective view of the completed process of attaching the PTZ camera(s) 20 is depicted, with the LED message board 22 and the flashing light assembly 11 attached, showing the surveillance system in its completed operational readiness configuration.

In reference to FIG. 3 the pan, tilt and zoom (PTZ) video surveillance camera(s) 20 with analytics and autonomous tracking capabilities and with the ability to store analytics information are a distinct improvement over previous embodiments of the existing art of security systems. While pan, tilt, and zoom (PTZ) cameras are well known in the surveillance industry as a means of providing video data, video recording and real time surveillance of a specified area to be secured, the previous embodiments of pan, tilt, and zoom (PTZ) cameras lack the abilities to analyze data and to make a decision, without human intervention, as to what actions to take upon capturing an event of interest or a possible breach of the protected security zone. These deficiencies of the previous embodiments of security systems are addressed in the claimed invention with the use of pan, tilt and zoom (PTZ) video surveillance camera(s) 20 with analytics and autonomous tracking capabilities and working in conjunction with a plurality of electronic devices including FIG. 3 an Object Tracking Central Processing Unit (OTCPU) 42, a Video Encoder 45, an Analytics Processor 48, a main CPU 44 and a plurality of communications devices.

In the embodiment of the claimed invention FIG. 3, the pan, tilt and zoom (PTZ) video surveillance camera(s) 20 with analytics and autonomous tracking capabilities have the abilities to provide surveillance to a pre-programmed pre-determined area as required by the user. Upon detection of a security breach, the PTZ camera(s) 20 in conjunction with the FIG. 3 OTCPU 42 communicates the detection of the breach to a video encoder 45 and to an analytics processor 48 which analyzes the video image data that has been captured by the PTZ camera(s) 20 and following a preset list of instructions that has been programmed into the main CPU 44 by authorized users, a determination is made by the plurality of analytical devices based on the preprogrammed instructions as to what actions, if any, need to be taken. If a determination is made that the breach in security requires the PTZ 20 to further investigate, the PTZ 20 is instructed by the main CPU 44 to begin the auto-tracking sequence, the PTZ 20 commences tracking the object of the security breach regardless of movement within the designated security zone and continues automated tracking until instructed to do otherwise.

In referring to FIG. 3, the PTZ 20 camera in conjunction with the object tracking CPU 42 makes use of algorithms pre-programmed into the PTZ 20 and the OTCPU 42 which analyze captured video data in real time and can automatically detect and classify unauthorized movement in pre-defined target zones and can automatically detect, track and zoom in on activity without human intervention.

Further referring to FIG. 3, upon detection and classification of an unauthorized movement or security breach, the PTZ 20 camera communicates the breach to the OTCPU 42 and the video encoder 45 through the communications central processing unit 46 and in conjunction with, and in communication with, the analytics processor 48 and the main CPU 44, a determination is then made as to what type of potential threat or breach has occurred and the incursion data is then analyzed by the plurality of electronic surveillance equipment. At this point a determination is made based on the analytical data and pre-programmed instructions that the authorized user has programmed into the main CPU 44 as to reporting the potential threat or security breach to authorized personnel. If the determination reached is to communicate the security breach the communications CPU 46 then reports to authorized users through a plurality of communication links including but not limited to, 3G cellular link 52, encrypted radio link 53, satellite link 54, Wi-Fi, ultra long range industrial grade wireless ethernet systems 128 bit hardware encryption keys and wired ethernet systems.

Upon receipt of the communication from the security system 10 in FIG. 1, the authorized user be it a central monitoring station, an authorized individual either on-site, at a remote location, or anyone else authorized to receive communicated information from, and communicate with, the surveillance system 10 can then review the video data communicated by the surveillance system 10 and make a determination as to what action needs to be taken. The authorized user at this point may communicate with the surveillance system through one, or more then one of the FIG. 3 aforementioned communications devices and instruct said surveillance system as to what course of action to follow. The authorized user has the option to take manual control of the surveillance system by communicating commands to the main CPU 44 and take manual control of the PTZ camera(s) 20 to further investigate the potential threat or security breach.

In further reference to FIG. 3, the PTZ 20 camera(s) working with the OTCPU 42 in conjunction with the analytics processor 48, the video encoder 45 and receiving instruction in the form of pre-programmed information from the main CPU 44 can autonomously classify objects from an object classification data base. This database can be customized for each client on an individual basis to watch and look for certain objects and areas that need to be secured. The advantage of this in the claimed invention is that unnecessary alarm events can be avoided by having the surveillance system look for only certain objects or events within a set of specific operational parameters programmed in the system, and report only if the specified objects or specified areas have been breached, moved, tampered with, or any number of events affecting said parameters.

In a further embodiment of the invention the analytics processor 48 in FIG. 3 has the ability through processing information received by the video encoder 45 and with information received from the analytics of the PTZ camera 20 to process and detect the following information, camera loss detection, if a camera is offline through a fault condition, damage, tampering or any event causing picture loss the event is reported. If a camera becomes obstructed for any reason from its' preprogrammed field of view the event is reported. The plurality of the video system is also capable of the following functions; motion tracking, object classification and virtual fence which allow the system to be programmed to provide surveillance over a specified area thus creating an electronic fence around a specific area. Wrong direction detection; this feature can monitor traffic flow, object or people movement and report any abnormal movement or activities that deviates from the pre-programmed parameters selected. Left item detection; if an object is left behind the video encoder 45 and the analytics processor 48 compare archived video information to see if the object was placed or left behind in an area where the item does not belong. Removed item detection; the video encoder 45 and the analytics processor 48 compare archived video information to see if an object has been removed from a designated area. People counting feature; the combined video analytics system can keep count of the number of people that have entered and left a specific area and compare the number that entered to the number that exited the area and record and report any discrepancies. All of the aforementioned features and capabilities can be switched on or off as determined by the authorized user and the surveillance system 10 can be configured and customized to meet the demands of the end user and the surveillance system can be configured for each unique situation.

Further in FIG. 3, the surveillance system 10 has the capabilities to be reprogrammed from a remote location through the communications links provided by the communications CPU 46. The communications CPU 46 allows two way communications with the main CPU 44 which in turn allows an authorized user, from any location, through the plurality of communications devices to change the surveillance configuration of the surveillance system by sending operational instructions to the main CPU 44 which in turn will communicate the new set of parameters and instructions to the plurality of electronic surveillance and communications equipment and reconfigure the surveillance system 10 to meet a specific need, or perform a desired task.

In reference to FIG. 1, a programmable LED digital message board 22 has been attached to the top of the security system. The function of the LED digital message board is to act as a highly visible message display system as has been disclosed in paragraph 015 of the claims section of this application. In reference to FIG. 3, the LED message board 22 is made programmable by the main CPU 44 which is used to program the desired message into the memory of the LED message board 22. The message displayed on the LED digital message board may also be programmed remotely via the communications CPU 46 which receives instructions from an authorized user through the plurality of communications devices. The communications CPU 46 then communicates the new message to be displayed via the main CPU 44 which in turn enters the new message into the LED message boards 22 onboard memory. In further reference to FIG. 1 a flashing light 11 is attached in some fashion to the top portion of the cabinet of the security system, the flashing light 11 can be programmed to trigger and flash upon detection of an alarm event, the programming and alarm triggering event(s) are controlled by the main CPU 44, the alarm triggering event(s) are programmed at the discretion of the authorized user, as to what type of alarm event(s) will cause the flashing light 11 to be activated.

In further reference to FIG. 3, the communications CPU 46 and the plurality of the communications subsystems have a variety of different functions including but not limited to, providing two-way communications links between the authorized users, i.e. a central monitoring station or a variety of authorized users at various remote locations, and the security system 10 FIG. 1. In reference to FIG. 3, in the embodiment of the claimed invention the communications CPU 46 including, without limitation, the 3G cellular link 52; encrypted radio link 53; satellite link 54; provides a continuous communication link to authorized users, a secondary function of the communications subsystem is to communicate any system faults, failures, required maintenance service or disruption in function of any subsystems of the surveillance system 10. The monitoring of the surveillance system subsystems is handled through the main CPU 44 FIG. 4 which receives communications of the faults, failures, or required service from the communications CPU 46 and communicates the fault, maintenance and service events via preprogrammed software in the main CPU 44 and sent out via the communications CPU 44 and the plurality of communications devices. When the GV-VSM (not shown) software programmed into the main CPU 44 is event triggered, instant text messages are sent via the communications sub-system to an authorized operator who will proceed with a diagnostic maintenance check on the surveillance system, the GV-VSM will send text messages and email alerts to assist the authorized operator in identifying which system requires maintenance or requires service. GV-VSM consists of an embedded software program that resides in the memory of the main CPU 44, where the programs primary function is to monitor the health status of the electronic components contained in the security system sub-system components, and to alert authorized users of the health status of these electronic components.

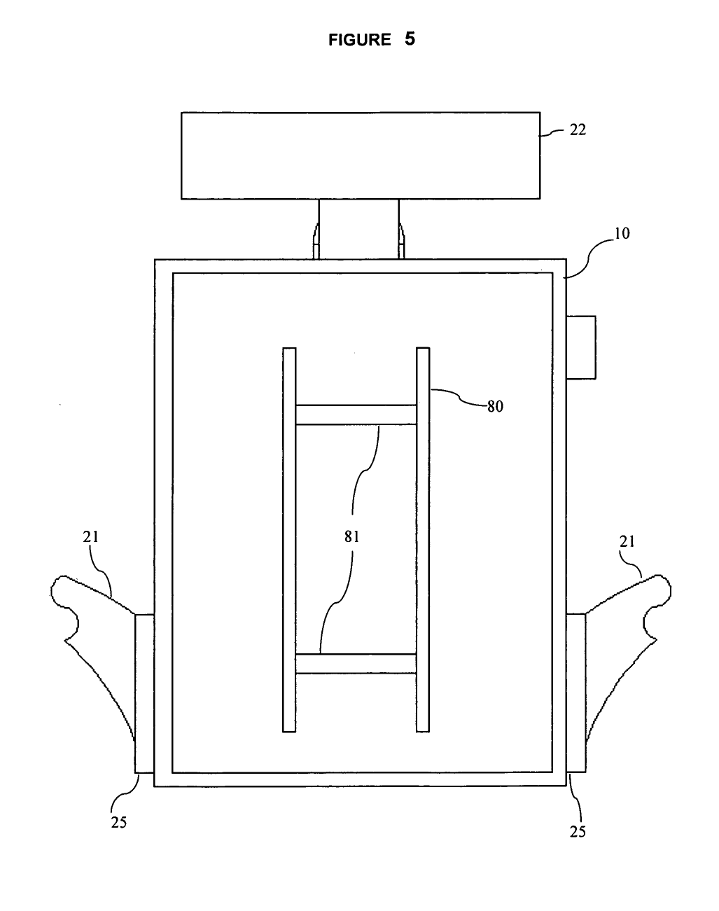

In reference to FIG. 5 the mounting bracket assembly is shown, the mounting bracket assembly is comprised of two adjustable vertical brackets 80 and two horizontal adjustable brackets 81, the said mounting brackets are pre-drilled at one inch increments (not shown) and are ready to accept any mounting configuration that is determined by the installation technician. The mounting brackets 80, and 81 are mounted to the cabinet enclosure by means of a series of nut and bolt combinations (not shown) and made sealable by rubberized grommets (not shown).

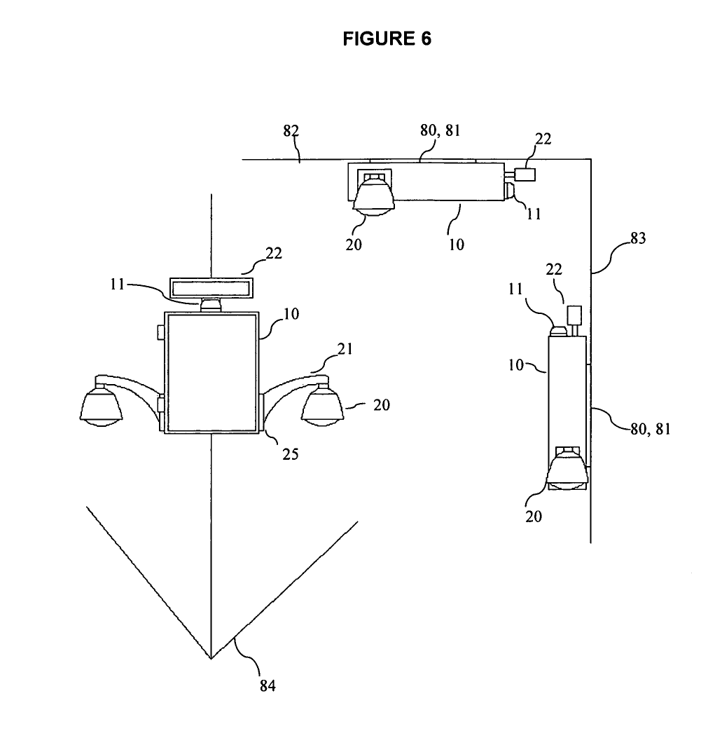

In reference to FIG. 6 the surveillance system 10 has a variety of mounting positions including but not limited to, wall mount, 83 ceiling mount 82 or corner mount 84. The security system can be attached to any type of structure that has the ability to support the unit, and the surveillance system 10 has been engineered for both interior and exterior installation and operation under extreme temperature and weather variants. The PTZ cameras 20 with the camera mounting arm 21 and the camera arm mounting plate 25 are designed to be fully adjustable to any position to allow the correct orientation of the PTZ cameras 20 to the area that is to be monitored. The PTZ cameras 20 are capable of a full 360 degree view from any unobstructed mounting location.

### DESCRIPTION OF PREFERRED EMBODIMENT

In the present embodiment of the invention the surveillance system has been designed and engineered to be a complete security system, contained in a compact enclosed cabinet that can be easily installed at any number of locations. The invention has been designed to remedy a wide variety of problems and deficiencies that exist with the current embodiments of surveillance systems in general. The claimed invention addresses the issues of having to run wiring and cable over long distances and the costs associated with this standard type of installation of a security system. The claimed invention also uses a plurality wireless communication devices, thus eliminating the need for hard wired communication links, and has the ability for two way communications with authorized users to report alarm activities, intrusions, system faults or any type of event that the user deems necessary to secure or survey an area. The claimed invention has the ability to perform a variety of functions including but not limited to, vehicle monitoring, people counting, the flow of inventory and merchandise, left item detection or moved object detection. The claimed invention has been successfully deployed as a permanently mounted surveillance system by bolting the steel frame to a concrete and steel pad made specifically to secure the surveillance system at entrances to factories to monitor traffic, people, and the flow of goods both in and out and report on those events. Other examples of a permanent mount have been schools and universities, factories, shopping centers and military installations, or any other area needing a permanent surveillance presence.

What the invention claim is:

1. A surveillance system comprising an environmentally protective enclosure to house a plurality of electronic equipment for the purpose of surveillance, communications, data transfer, power distribution and other electronic apparatus and surveillance functions.

2. The surveillance system of claim 1 having a generally hollow camera mounting arm for connecting the PTZ camera(s) to the various electronic sub-systems housed within the protective box enclosure.

3. The surveillance system of claim 2 wherein the generally hollow camera mounting arm forms an airtight waterproof seal through a rubberized gasket, mounting plate and polymer nut/washer arraignment that attaches said camera mounting arm to the side of the cabinet and allows wires and cable to attach the PTZ camera to the electronics sub-systems contained within said protective box enclosure.

4. The surveillance system of claim 1 wherein the door assembly comprises a rubberized gasket to prevent entry of water, moisture and particulate matter when door is in a closed and locked position.

5. The surveillance system of claim 1 having a breaker switch connected to a standard power source to provide power to the plurality of electronic equipment.

6. The surveillance system of claim 1 wherein the box enclosure has a metal frame mounting bracket assembly attached to the outside back of the box to allow installation of said box in an upright vertical position when attached to a vertical surface.

7. The surveillance system of claim 4 wherein the box enclosure contains one or more batteries connected to the plurality of electronic equipment through the power distribution center to provide emergency back-up power as may be required in power outage or emergency situations.

8. The surveillance system of claim 6 where the box enclosure contains a series of electric fans to provide cooling to the electronic components, and secondly, to promote rapid evaporation of any moisture or condensation that may enter the cabinet.

9. A distinct advantage of the embodiment of the invention is the ability of the self-contained wall mountable surveillance system to automatically and without human intervention detect, analyze and classify unauthorized movement in pre-defined target zones. This is achieved through the use of a specific type of pan, tilt and zoom (PTZ) video surveillance camera with analytics capabilities with an object tracking central processing unit (the term central processing unit is referred to herein as “CPU”) and possessing the ability to store said analytics capabilities within the camera memory and having the ability to autonomously analyze and automatically track a target upon detection of an intrusion event. In combination with an analytics processor and video encoder that has the capabilities to analyze and classify image information, instruct electronic surveillance devices, and to record, archive, retrieve, communicate, and receive communications via a plurality of communication devices. Said surveillance system then communicates electronically by means of one or a combination of, but not limited to the following communication devices, satellite link, Wi-Fi, cellular, ultra long range industrial grade wireless ethernet systems 128 bit hardware encryption keys and wired ethernet systems to report said unauthorized movement or violation and await further instructions from an authorized user while continuing to automatically and autonomously track and record and or display in real time to an authorized user, or including but not limited to a continuously manned central monitoring station. Said target remains acquired and tracked and recorded throughout the communication process while said instructions are being communicated via secure link to said surveillance system.

10. The self-contained wall mountable surveillance system of claim 9 wherein the PTZ video camera(s) has the capabilities of storing analytics data information.

11. The self-contained wall mountable surveillance system of claim 9 wherein the video encoder has the ability to store, analyze, receive, communicate and share analytical data with the video camera.

12. The self-contained wall mountable surveillance system of claim 011 wherein the video camera and video encoder can engage in two way real time communications and instruct and share information in conjunction with an object tracking CPU and analytics processor and selectively target and track an intrusion of a protected surveillance zone autonomously without human intervention.

13. The video encoder of claim 012 has the capabilities to communicate via a plurality of communications devices to report intrusion activities to an authorized user or central monitoring station and communicate exact type and circumstances of intrusion and provide analytical archived video and real time data of intrusion event reported, said authorized user then has option to take manual control of video encoder, said PTZ cameras and the self-contained wall mountable surveillance system to determine the type of threat, intrusion or violation and what action needs to be taken.

14. The video encoder of claim 013 wherein the video encoder upon receipt of instructions from an authorized user can communicate said instructions to video cameras and continue to follow said instructions from authorized user until said authorized user has released control of the self-contained wall mountable surveillance system, wherein the system will revert back to its autonomous operational mode.

15. A further embodiment of the invention is a programmable light emitting diode (referred to herein as “LED”) digital message board with programmable visual scrolling message text to visually announce that the area is under twenty-four hour continuous video and security monitoring, the LED digital message board is affixed on a metal bar which is attached in some fashion to the metal cabinet. This positioning of the programmable LED message board allows for maximization of visibility from the maximum distance. The purpose of said programmable LED message board is to visually announce the presence of surveillance and to counteract and discourage any potential violators from unauthorized breaching or intruding upon the preprogrammed security zone, and that any and all potential violators of the security zone will be monitored, tracked, photographed and recorded both in archived video and in real time video and that appropriate responders to the breach of said security zone may be dispatched to investigate said security breach.
